(19) United States
(12) Patent Application Publication
(10) Pub. No.: US 2020/0311583 A1
(43) Pub. Date: Oct. 1, 2020

(54) SYSTEM AND METHODS FOR FAULT TOLERANCE IN DECENTRALIZED MODEL BUILDING FOR MACHINE LEARNING USING BLOCKCHAIN

(71) Applicant: Hewlett Packard Enterprise Development LP, Houston, TX (US)

(72) Inventors: SATHYANARAYANAN MANAMOHAN, Chennai (IN); Krishnaprasad Lingadahalli Shastry, Bangalore (IN); Vishesh Garg, Bangalore (IN); Eng Lim Goh, Singapore (SG)

(21) Appl. No.: 16/372,098

(22) Filed: Apr. 1, 2019

(51) Int. Cl. G06N 5/04; G06N 20/20; H04L 9/06

(52) U.S. Cl. CPC G06N 5/043; G06N 20/20; H04L 2209/38; H04L 9/0643; H04L 9/0637

(57) ABSTRACT

Decentralized machine learning to build models is performed at nodes where local training datasets are generated. A blockchain platform may be used to coordinate decentralized machine learning (ML) over a series of iterations. For each iteration, a distributed ledger may be used to coordinate the nodes communicating via a decentralized network. A master node on the decentralized network, can include fault tolerance features. Fault tolerance involves determining whether a number of computing nodes in a population for participating in an iteration of training is above a threshold. The master node ensures that the minimum number of computing nodes for a population, indicated by the threshold, is met before continuing with an iteration. Thus, the master node can prevent decentralized ML from continuing with an insufficient population of participating node that may impact the precision of the model and/or the overall learning ability of the decentralized ML system.

### DESCRIPTION OF RELATED ART

Efficient model building requires large volumes of data. While distributed computing has been developed to coordinate large computing tasks using a plurality of computers, applications to large scale machine learning (“ML”) problems is difficult. There are several practical problems that arise in distributed model building such as coordination and deployment difficulties, security concerns, effects of system latency, fault tolerance, parameter size and others. While these and other problems may be handled within a single data center environment in which computers can be tightly controlled, moving model building outside of the data center into truly decentralized environments creates these and additional challenges. For example, a system for decentralized ML may be within a limitedly-distributed computing environment, having a finite number of computing nodes. Thus, a relatively smaller number of nodes can participate in ML-based processes in these computing environments, in comparison to open approaches that may theoretically use an unlimited number of nodes (e.g., federated ML). The contribution of each node in decentralized ML may be more valuable in such computing environments with a limited population of participating nodes. Thus, it may be desirable to further adapt decentralized model building to achieve fault tolerance. Fault tolerance may prevent the complete loss of a node (or group of nodes) throughout the decentralized model building process and mitigate the impact of a failed node (or group of nodes) on the overall learning ability of the ML system.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 depicts an example of a system of decentralized model building for machine learning (ML) using blockchain including fault tolerance, according to some embodiments.

FIGS. 2A-2B illustrate an example nodes in the system of decentralized model building shown in FIG. 1 communicating in accordance with fault tolerance techniques, according to some embodiments.

FIG. 3 illustrates an example of a node configured for performing the fault tolerance techniques shown in FIGS. 2A-2B, according to some embodiments.

FIG. 4 is an operational flow diagram illustrating an example of a process of an iteration of model building for ML using blockchain, according to some embodiments.

FIG. 5 is an operational flow diagram illustrating an example of a process for fault tolerance that may be performed by a master node shown in FIGS. 2A-2B, according to some embodiments.

FIG. 6 illustrates an example computer system that may be used in implementing fault tolerance in decentralized model building for ML using blockchain relating to the embodiments of the disclosed technology.

The figures are not exhaustive and do not limit the present disclosure to the precise form disclosed.

### DETAILED DESCRIPTION

Various embodiments described herein are directed to a method and a system for fault tolerance of a computer node in decentralized model building for machine learning (ML) using blockchain. In some distributed computing environments, such as enterprise systems (e.g., a computer networking system operating in a domain controlled by a particular organization or enterprise), there may be a finite number of computing resources that are present, or otherwise available for use. A distributed computing environment may be limited to a relatively small population, or number of computers available, due to a number of varying factors, such as data privacy concerns, organizational structure, restricted network access, computer inventory, and the like. For example, only a subset of computers within an enterprise network may be authorized to access the information needed for a training dataset in ML. Accordingly, data privacy restrictions associated with the enterprise environment can further restrict the number of computers in the enterprise network that can qualify for participating in the ML process. In general, limitedly-distributed computing environments typically have fewer computing nodes that can be contributors in decentralized model building, as disclosed herein. In order for some current ML techniques to operate with the expected precision using computers of a limitedly-distributed computing environment, there is an implied requirement that substantially all of the participating nodes are available and contributing their respective learning during model building for ML. Additionally, in order to maintain a desirable accuracy for ML within limitedly-distributed computing environment, these existing ML approaches may further require that any failed node be recovered almost immediately (e.g., short node down-time). Continuing ML while a participating node has failed has the potential to corrupt the data (e.g., partial learning, missing data from training datasets) used throughout the system, as ML is a heavily collaboration process. Thus, a single down node can negatively affect the learning at other nodes, which can ultimately cause degradation of the respective local models and reduce the overall effectiveness of the system.

In some cases, a model can increasingly degrade in a manner that is proportional to the downtime of the participating node. For example, a node's absence from a model building process having a finite number of participants negatively affects the ML. Therefore, maintaining the proper function of every computer in the system can reduce the likelihood of these problems and improve the precision of ML. Nonetheless, it may be inevitable for at least one computer that is participating in ML to experience unintended failures in real-world scenarios.

As a concept of machine learning, the presence of more data (e.g., increasing the size of the data set) can enhance overall performance and result in improved models. Thus, accuracy of models for ML may be tied to the number of computers that can actively participate in the ML process (with the assumption that an increase in the population, in turn increases the amount of data contributed for model building). Accuracy, as discussed with respect to ML, may be a measurement of correctness for ML-based predictions, (e.g., a ratio of the number of correct predictions to the total number of input samples). For instance, a ML model that correctly makes 98 predictions from a set of 100 samples can be described as having 98% training accuracy. Thus, it is often desirable to have a ML model that can identify relationships and patterns between variables in a dataset based on the input (e.g., training data) with a high degree of accuracy. Some example characteristics of accuracy in the realm of machine learning can involve a low rate of false positives and false negatives. Moreover, a precise ML model can be described as a model that makes very few inaccurate predictions. For instance, a ML model that produces no false positives can be considered to have high precision. For purposes of discussion, both accuracy and precision are described herein as metrics for evaluating the quality of machine learning tools.

As an example, a decentralized model building process having a population of 100 computers acting as participant nodes may contribute a larger amount of data, and result in a more precise and/or accurate model than a process having a population of only five computers. In some instances, it may be known that a certain number of computers must be involved in collaborative ML, in order for the model to be built at a suitable precision for the desired application. That is, accuracy (and precise) predictions can hold greater value in some real world applications, such as the medical industry (e.g., predicting whether a tumor is benign). Thus, the level of accuracy (and precision) that is considered suitable for ML models in medical applications may be higher than needed in other applications. Furthermore, in general, ML models aim to minimize the presence of bias (e.g., difference between predicted and observed values) and variance (e.g., difference in performance across different data sets). Referring back to the example, building a model from a population of only five computers can result in a dataset that includes a small number of data points (as compared to 100 computers). The size of the dataset can directly impact a model's overall performance, and small data sizes tend to be more prone to unwanted bias, variance, and are more susceptible to outliers and noise. Such small-data ML models can have less accuracy, precision, and are thereby less powerful for practical applications. However, as the number of participant nodes increases, which in turn presents a more robust dataset for training the model, the accuracy and precision tends to improve. Therefore, in the example, the ML models generated from 100 computers may perform better than the ML model from five computers. For instance, a ML model trained using five computers may have 20% accuracy, while the ML model trained using 100 computers may have 95% accuracy. Accordingly, it may be desirable to integrate fault tolerance that focuses on ensuring that the number of nodes needed to act as participants (e.g., contributing accurate data), hereinafter referred to as the population, are present during decentralized model building.

As alluded to above, implementing fault tolerance at the population-level in decentralized model building for ML can address some of the potential drawbacks associated with limitedly-distributed computing environments. For instance, in the event a node loses communication with the network, achieving fault tolerance based on the population size of participating nodes can maintain an expected accuracy of ML models even within limitedly-distributed computing environments. According to the embodiments, a master node, can employ the fault tolerance techniques to safeguard against continuing model building while the population size of participant nodes is insufficient (e.g., below a threshold). The fault tolerance techniques allow time for the population to recover to a sufficient size, for example allowing self-healing of nodes within the population to automatically reintegrate themselves into the decentralized machine learning process (thereby increasing the number of active nodes in the population). Accordingly, the decentralized ML system can tolerate one or more node faults within its population in a manner that does not negatively impact the accuracy of ML.

Furthermore, some existing ML approaches are used in environments that are not confined to limitedly-distributed computers. For instance, many federated systems used for ML have a setting where the centralized model is trained with training data distributed over a large number of computing devices, and typically over a public or unrestricted communication network. For example, federated ML can be applied to mobile or internet of things (IoT) scenarios in which models are trained from information processed across hundreds of thousands (and in some cases millions) of devices having network connectivity capabilities. Due to the large pool of ML participants and the open accessibility of data, the loss of a few nodes in a federated ML application can have a less significant impact to the overall learning ability of the system, as compared to limitedly-distributed computing environments. As such, many of these existing ML approaches do not implement fault tolerance at the population-level in the manner of the disclosed embodiments. Although high accessibility may be advantageous for the general concept of ML, there may be instances, such as maintaining the privacy of data, where federated ML approaches may not be desirable.

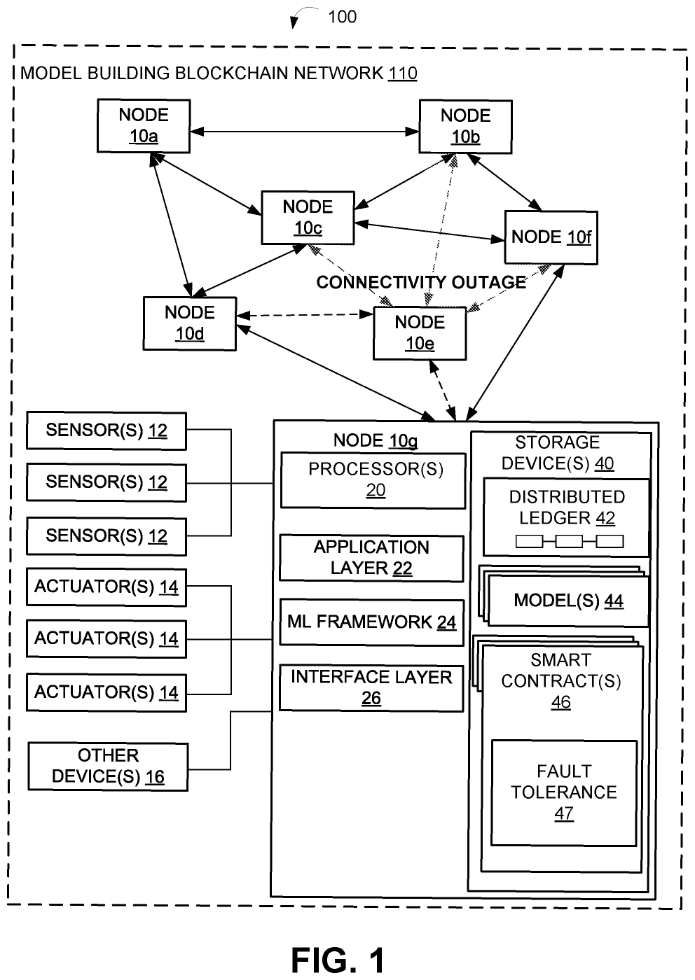

Referring to FIG. 1, an example of a system 100 of decentralized model building for machine learning (ML) using blockchain is shown. According to the embodiments, the system 100 performs decentralized parallel ML at nodes 10a-10g over multiple iterations in a blockchain network 110. System 100 may include a model building blockchain network 110 (also referred to as a blockchain network 110) that includes a plurality of computer nodes (also referred to herein as “computing nodes”), or computer devices. Generally, a blockchain network 110 can be a network where nodes 10a-10g use a consensus mechanism to update a blockchain that is distributed across multiple parties. In some instances, the network 110 can be implemented as a network in accordance with other decentralized technologies (also referred to as a decentralized network) in addition to blockchain. The particular number, configuration and connections between nodes 10a-10g may vary. As such, the arrangement of nodes 10g shown in FIG. 1 is for illustrative purposes only. A node, such as node 10g may be a fixed or mobile device. Examples of further details of a node 10g will now be described. While only one of the nodes 10g is illustrated in detail in the figures, each of the nodes 10a-10g may be configured in the manner illustrated.

FIG. 1 also depicts that node 10g is configured to implement fault tolerance techniques, as disclosed herein. Through the use of blockchain in ML, the embodiments can leverage state-awareness properties associated with a distributed ledger to achieve fault tolerance. In some cases, each of the nodes 10a-10g in system 100 may be similarly configured for fault tolerance. Furthermore, by including the fault tolerance feature at the nodes 10a-10g, the system 100 can continue model building even in the presence of intermittent faults. In the illustrated example of FIG. 1, nodes 10a-10e may be referred to as the population of participating computer nodes for the decentralized ML process.

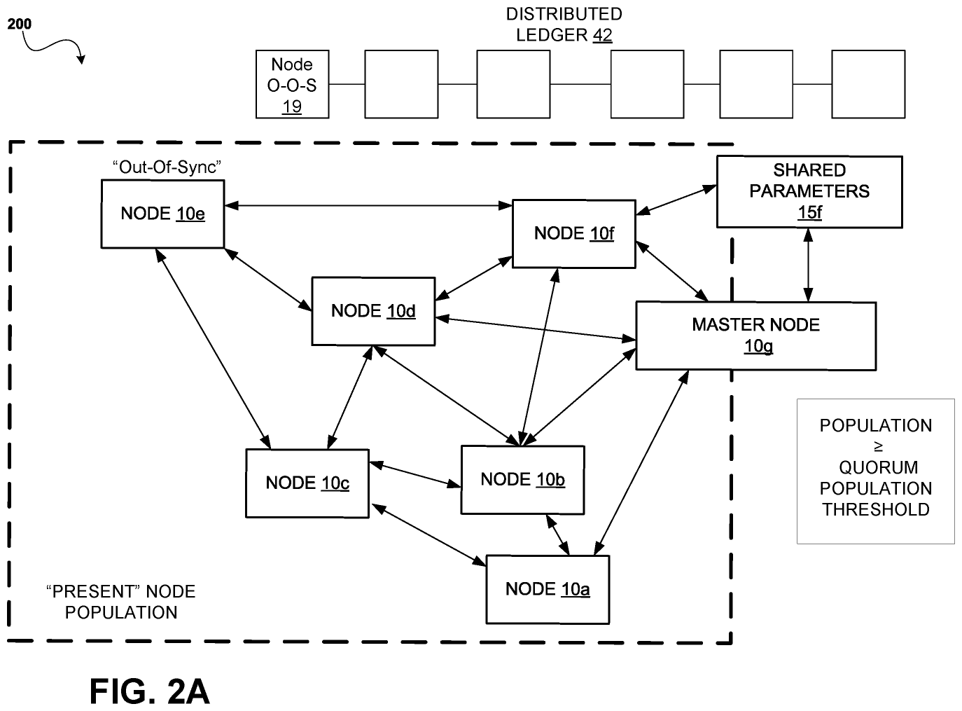

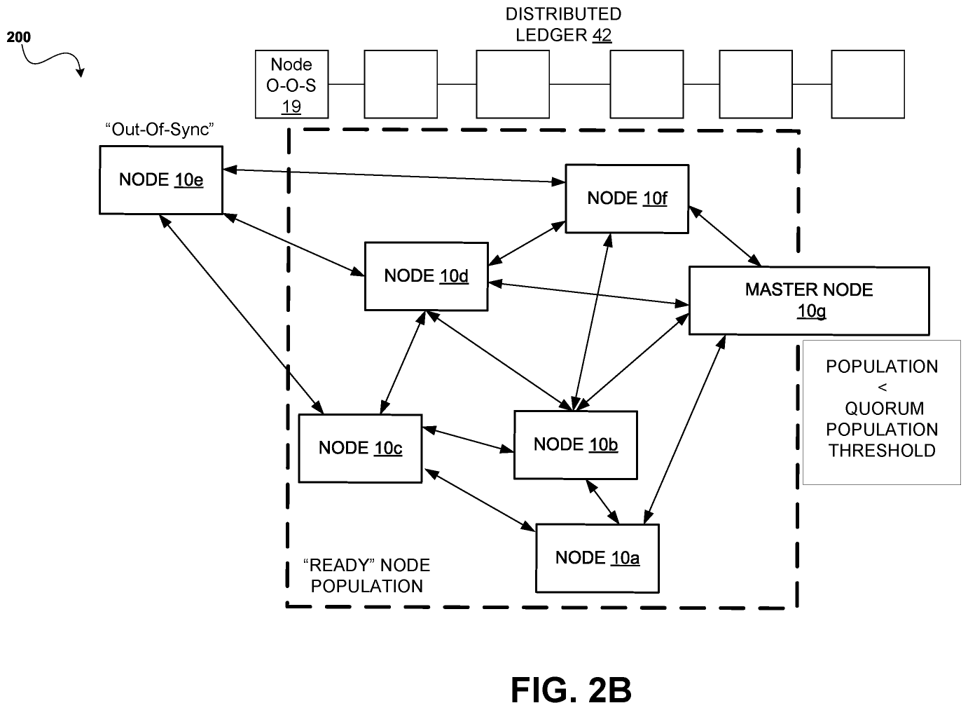

As an example, FIG. 1 illustrates that node 10e can experience a connectivity outage, where previously established connections from node 10e to other nodes 10a-10d, 10f, and 10g in the network 110 (shown by dashed lines) may fail temporarily. For instance, a wireless antenna of node 10e can malfunction, causing its peer-to-peer wireless links between nodes 10d, 10f, and 10g to be lost. As a result, a node 10e may be communicatively disconnected from the other nodes 10a-10d, 10f, and 10g in system 100. In some cases, a connectivity outage can cause node 10e to be disconnected from the entire blockchain network 110. Accordingly, node 10e may not be capable of participating in model building, due to its lost connectivity and inability to properly collaborate with the other nodes 10a-10d, 10f, and 10g in the blockchain network 110. In accordance with the fault tolerance techniques, as described in greater detail in reference to FIGS. 2A-2B, node 10g can become aware of the fault experienced by node 10e, and thus exclude node 10g from the population during model building. It should be appreciated that a connectivity outage is described as a fault scenario for purposes of illustration, and other forms or node related faults, or failures, can also cause node 10g to initiate fault tolerance techniques. Examples of fault scenarios that may require fault tolerance, for example pausing machine learning such that it allows time for node 10e to return to nominal ML operations, can include but are not limited to: power outages; software failures; computer system crash; computer system reboot; security attacks; and the like. For purposes of discussion, a node that is experiencing any of the abovementioned fault scenarios or is otherwise unable to participate in the ML process, in whole or in part, may be referred to hereinafter as a “down” node or “self-healing” node. Another aspect of fault tolerance involves the population recovering from a fault condition occurring at a computer node on the blockchain network.

There can be a number of challenges associated with realizing fault tolerance associated with dynamic population sizes in some existing ML systems that do not utilize blockchain technology, in the manner of the embodiments. For example, connections between nodes 10a-10g in system 100 may be implemented entirely using peer-to-peer networking. In most cases, peer-to-peer connections are established temporarily. Therefore, it may be difficult for the other nodes 10a-10d, 10f, and 10g in the blockchain network 110 to be able to detect that node 10e has become unavailable due to experiencing a fault (as opposed to an intended disconnection of a peer-to-peer link), such as a connectivity outage, in a robust manner. Similarly, the node 10e may not be equipped to detect for itself, that it has encountered a fault. For instance, in the case when node 10e has restarted after a connectivity outage, the node 10e may not have the capabilities to determine that the connectivity outage previously occurred. Nonetheless, blockchain includes a structure, namely the distributed ledger 42, that is capable of maintaining the state of each of the nodes 10a-10g in the system 100. Thus, state-awareness that is provided by the blockchain can be used by fault tolerance techniques, so as to allow a down node (e.g., experiencing a fault) to be detectable by the other nodes in the system 100, namely node 10g. Even further, blockchain is leveraged such that node 10e has the capability to be self-aware of an encountered fault condition.

Additionally, as previously described, a fault at a single node can potentially impact the entire model building process. Thus, in some embodiments, fault tolerance also includes node-level tolerance, for example self-healing. In self-healing, various corrective actions may need to be performed prior to allowing a self-healed node to re-participate in the model building process. Blockchain technology includes synchronization mechanisms that can be applied in order to re-synchronize a restarted node 10e with the system 100, further enhancing fault tolerance aspects of the embodiments. In general, synchronization ensures that a self-healed node is properly reintegrated into the decentralized model building process in a manner that maintains the overall effectiveness of ML.

According to the embodiments, node 10g includes a fault tolerance module 47. The fault tolerance module 47 can program node 10g to execute various functions that allow the node 10g to automatically ensure that the population of participant nodes in the model building of system 100 is greater than a threshold, prior to continuing the model building in accordance with the techniques described herein. Furthermore, according to various implementations, node 10g and components described herein may be implemented in hardware and/or software that configure hardware. The fault tolerance module 47 is shown as a modular portion of the rules realized by smart contracts 46. In particular, rules encoded by the fault tolerance module 47 can enable decentralized model building to function in a fault tolerant manner, as previously described.

Node 10g may include one or more sensors 12, one or more actuators 14, other devices 16, one or more processors 20 (also interchangeably referred to herein as processors 20, processor(s) 20, or processor 20 for convenience), one or more storage devices 40, and/or other components. The sensors 12, actuators 14, and/or other devices 16 may generate data that is accessible locally to the node 10e. Such data may not be accessible to other participant nodes 10a-10f in the model building blockchain network 110.

FIG. 1 shows that the storage device(s) 40 may store: distributed ledger 42; model(s) 44; and smart contract(s) 46 including the fault tolerance model 47, The distributed ledger 42 may include a series of blocks of data that reference at least another block, such as a previous block. In this manner, the blocks of data may be chained together. The distributed ledger 42 may store blocks that indicate a state of a node 10e relating to its machine learning during an iteration. Thus, the distributed ledger 42 may store an immutable record of the state transitions of a node 10e. In this manner, the distributed ledger 42 may store a current and historic state of a model 44. It should be noted, however, that in some embodiments, some collection of records, models, and smart contracts from one or more of other nodes may be stored in distributed ledger 42.

The distributed ledger 42, transaction queue, models 44, smart contracts 46 including fault tolerance module 47, and/or other information described herein may be stored in various storage devices such as storage device 40. Other storage may be used as well, depending on the particular storage and retrieval requirements. For example, the various information described herein may be stored using one or more databases. Other databases, including file-based, or query formats, platforms, or resources such as OLAP (On Line Analytical Processing), SQL (Structured Query Language), a SAN (storage area network), or others may also be used, incorporated, or accessed. The database may comprise one or more such databases that reside in one or more physical devices and in one or more physical locations. The database may store a plurality of types of data and/or files and associated data or file descriptions, administrative information, or any other data.

The node 10e can store a training dataset locally in storage device(s) 40. Model 44 may be locally trained at a node 10g based on locally accessible data such as the training dataset, as described herein. The model 44 can then be updated based on model parameters learned at other participant nodes 10a-10g that are shared via the blockchain network 110. The nature of the model 44 can be based on the particular implementation of the node 10e itself. For instance, model 44 may include trained parameters relating: to self-driving vehicle features such as sensor information as it relates object detection, dryer appliance relating to drying times and controls, network configuration features for network configurations, security features relating to network security such as intrusion detection, and/or other context-based models.

The smart contracts 46 may include rules that configure nodes 10e to behave in certain ways in relation to decentralized machine learning. For example, the rules may specify deterministic state transitions, when and how to elect a master node, when to initiate an iteration of machine learning, whether to permit a node to enroll in an iteration, a number of nodes required to agree to a consensus decision, a percentage of voting nodes required to agree to a consensus decision, and/or other actions that a node 10e may take for decentralized machine learning.

Processors 20 may be programmed by one or more computer program instructions. For example, processors 20 may be programmed to execute an application layer 22, a machine learning framework 24 (illustrated and also referred to as ML framework 24), an interface layer 26, and/or other instructions to perform various operations, each of which are described in greater detail herein. The processors 20 may obtain other data accessible locally to node 10e but not necessarily accessible to other participant nodes 10a-10d, 10f, and 10g as well. Such locally accessible data may include, for example, private data that should not be shared with other devices. As disclosed herein, model parameters that are learned from the private data can be shared according to parameter sharing aspects of the embodiments.

The application layer 22 may execute applications on the node 10g. For instance, the application layer 22 may include a blockchain agent (not illustrated) that programs the node 10g to participate and/or serve as a master node in decentralized machine learning across the blockchain network 110 as described herein. Each node 10a-10g may be programmed with the same blockchain agent, thereby ensuring that each node acts according to the same set of decentralized model building rules, such as those encoded using smart contracts 46. For example, the blockchain agent may program each node 10 to act as a participant node as well as a master node (if elected to serve that roll). The application layer 22 may execute machine learning through the ML framework 24.

The ML framework 24 may train a model based on data accessible locally at a node 10g. For example, the ML framework 24 may generate model parameters from data from the sensors 12, the actuators 14, and/or other devices or data sources to which the node 10e has access. In an implementation, the ML framework 24 may use a machine learning framework, although other frameworks may be used as well. In some of these implementations, a third-party framework Application Programming Interface (“API”) may be used to access certain model building functions provided by the machine learning framework. For example, a node 10e may execute API calls to a machine learning framework. The machine learning framework may refer to any platform that provides tools and/or libraries to build, train, and/or deploy ML models, such as, TensorFlown™.

The application layer 22 may use the interface layer 26 to interact with and participate in the blockchain network 110 for decentralized machine learning across multiple participant nodes 10a-10g. The interface layer 26 may communicate with other nodes using blockchain by, for example, broadcasting blockchain transactions and, for a master node elected as describe herein elsewhere, writing blocks to the distributed ledger 42 based on those transactions as well as based on the activities of the master node.

Model building for ML may be pushed to the multiple nodes 10a-10g in a decentralized manner, addressing changes to input data patterns, scaling the system, and coordinating the model building activities across the nodes 10a-10g. Moving the model building closer to where the data is generated or otherwise is accessible, namely at the nodes 10a-10g, can achieve efficient real time analysis of data at the location where the data is generated, instead of having to consolidate the data at datacenters and the associated problems of doing so. Without the need to consolidate all input data into one physical location (data center or “core” of the IT infrastructure), the disclosed systems, methods, and non-transitory machine-readable storage media may reduce the time (e.g., model training time) for the model to adapt to changes in environmental conditions and make more accurate predictions. Thus, applications of the system may become truly autonomous and decentralized, whether in an autonomous vehicle context and implementation or other IoT or network-connected contexts.

According to various embodiments, decentralized ML can be accomplished via a plurality of iterations of training that is coordinated between a number of computer nodes 10a-10g. In accordance with the embodiments, ML is facilitated using a distributed ledger of a blockchain network 110. Each of the nodes 10a-10g can enroll with the blockchain network 110 to participate in a first iteration of training a machine-learned model at a first time. Each node 10a-10g may participate in a consensus decision to enroll another one of the computing nodes to participate in the first iteration. The consensus decision can apply only to the first iteration and may not register the second physical computing node to participate in subsequent iterations.

Fault tolerance techniques of the embodiments can involve requiring a specified number of nodes 10a-10g to be registered for an iteration of training, which translates to a minimum number of nodes that may be required to be actively present in the population of participant nodes. Thereafter, each node 10a-10g may obtain a local training dataset that is accessible locally but not accessible at other computing nodes in the blockchain network. The node 10g may train a first local model 44 based on the local training dataset during the first iteration and obtain at least a first shared training parameter based on the first local model. Similarly, each of the other nodes 10a-10f on the blockchain network 100 can train a local model, respectively. In this manner, node 10g may train on data that is locally accessible but should not (or cannot) be shared with other nodes 10a-10f. Node 10g can generate a blockchain transaction comprising an indication that it is ready to share the shared training parameters and may transmit or otherwise provide the shared training parameters to a master node. The node 10g may do so by generating a blockchain transaction that includes the indication and information indicating where the training parameters may be obtained (such as a Uniform Resource Indicator address). When some or all of the participant nodes are ready to share its respective training parameters, a master node (also referred to as “master computing node”) may write the indications to a distributed ledger. The minimum number of participants nodes that are ready to share training parameters in order for the master node to write the indications may be defined by one or more rules, which may be encoded in a smart contract, as described herein.

Node 10e, which is illustrated as experiencing a connectivity outage in FIG. 1, may be temporarily incapable of communicating via the blockchain network 110. Furthermore, node 10e may not be able to transmit a blockchain transaction to update its state during the connectivity outage. In this instance, node 10g acting as the master node can determine that it failed to receive a blockchain transaction particularly from node 10e. In accordance with the disclosed techniques, detecting a missing blockchain transaction can signal to the master node 10g that node 10e is down. Thus, the blockchain allows at least a master node 10g to be aware that node 10e may be experiencing a fault that is preventing the node 10e from communication via the blockchain network 110. In some cases, node 10g can be triggered to execute the fault tolerance techniques by detecting a fault condition in this manner. Furthermore, the down node 10e, being unable to connect to its peers or the blockchain network 110, may be unable to share its local training parameters to the other nodes 10a-10d, 10f, and 10g. During the connectivity outage, the node 10e also may not receive updated training parameters from the blockchain. Consequently, even after node 10e has regained connectivity, data local to node 10e may be outdated. As an example, parameters from the most recent iteration may not have been successfully received by node 10e during the connectivity outage. To prevent stale data from being injected in the model building process, fault tolerance module 47, at node 10g (acting as master node in this example), can exclude node 10e from model building until the node 10e is synchronization with the system 100 in a manner that reconciles for this loss of data before it continues participation in the decentralized model building process. Fault tolerance, as disclosed herein, can include node 10g determining whether node 10e being down warrants excluding it from acting as a participant node. Furthermore, the fault tolerance module 47 at node 10g can determine whether the exclusion of node 10e causes the population of participant nodes to drop below the threshold. In some cases, fault tolerance module 47 causes node 10g to pause the model building process until the population again reaches the threshold. While machine learning is temporarily halted by node 10g, it may allow node 10e to automatically perform the actions necessary to recover and be reintroduced into the ML, potentially bringing the participant population of the system 100 back above a threshold size after a fault. For purposes of illustration, FIG. 1 illustrates node 10g as including the fault tolerance module 47. Nonetheless, it should be appreciated that any, all, or some combination of in the network 110, such as nodes 10a-10f can include the fault tolerance module 47 and perform the functions as described herein.

FIGS. 2A-2B illustrate an example of nodes 10a-10g of blockchain network 200 communicating in accordance with the fault tolerance techniques described above. FIGS. 2A-2B illustrate an “out-of-sync” node 10e communicating to the master node 10g in a manner that provides fault tolerance during model building (also referred to herein as machine learning or model training). For purposes of illustration, the process is shown as a first phase (primarily shown in FIG. 2A) prior to excluding node 10e from the model building process by the master node 10g, and a second phase (primarily shown in FIG. 2B) after the node 10e has been excluded. FIG. 2A also depicts a distributed ledger 42 that is global to the blockchain network 200. As alluded to above, FIGS. 2A-2B show node 10g acting as the master node for this illustrated example. Each of the other nodes enrolled to participate in an iteration, namely nodes 10a-10d, and 10f, are referred to herein as a “participant node.” According to the fault tolerance techniques, there is a minimum number of participants nodes in the population that must be ready to share training parameters in order for the master node 10g to continue with the iteration of training. This minimum number of nodes may be referred to hereinafter as the quorum population threshold. The quorum population threshold may be a quantitative value, such as a number, count, a percentage, etc., relating to a required minimum for the population size of participant nodes that is deemed sufficient to maintain a desirable level of precision for building models and/or an overall learning ability of the ML system. In other cases, the quorum population threshold may be a qualitative value. The quorum population threshold can be defined by one or more rules, which may be encoded in the fault tolerance aspects of the smart contract, as described herein. Furthermore, the quorum population threshold may be either a static value, or a dynamic value that may be adjusted based on a number of relevant factors such as the specific application, desired precision level of generated models, characteristic of the distributed environment, and the like.

As previously described, the distributed ledger 42 can contain information indicating the state of each of the nodes 10a-10g. Accordingly, the distributed ledger 42 can be used to enable state-awareness capabilities for the nodes 10a-10g on the blockchain network 200. In reference to FIG. 2A, the first phase can include the participant nodes 10a-10d, and 10f training their respective local models using local training datasets. For example, each of the participating nodes 10a-10d, and 10f can query a local copy of the distributed ledger 42 to obtain information regarding the current state of the other nodes in the blockchain network. The participating nodes 10a-10d, and 10f can actively contribute during an iteration of model building. The iteration can involve the participating nodes 10a-10d, and 10f having a training dataset that may be accessible locally to the participant node but not to other nodes. As such, each participant node 10a-10d, and 10f can generate model parameters resulting from the local training dataset, referred to herein as shared parameters. As a result, the participant nodes 10a-10d, and 10f may each share their respective model parameters, as shared parameters, with other participants in the blockchain network 200. For example, each participant node 10a-10d, and 10f may communicate its shared parameter to a master node 10g, which is elected from among the nodes in the blockchain network 200. Furthermore, each of the participant node 10a-10d, and 10f can update its current ML state in the distributed ledger 42. In particular, the example in FIG. 2A illustrates participant node 10f communicating its respective shared parameters 15f to the master node 10g.

As seen in FIG. 2A, the master node 10g can be included in the blockchain network 200. The master node 10g may generate a new transaction to be added as a ledger block to each copy of the distributed ledger based on the indication that one of the participating nodes 10a-10d, and 10f is ready to share its shared training parameter, for example. The master node 10g may be elected from among the other nodes 10a-10e by consensus decision or may simply be selected based on being the first node to enroll in the iteration. FIG. 2A illustrates nodes 10a-10d, and 10f as the participant nodes in the blockchain network 200. According to the embodiments, participant nodes 10a-10d, and 10f can train a local model using training data that is accessible locally at the node, but may not be accessible at another node. However, training parameters learned from such data through machine learning can be shared, as the training parameters typically do not expose raw data (which may be comprised of sensitive information). When the training parameters are determined by a node, the node may broadcast an indication that it is ready to share the training parameters. For example, participant node 10f, after training its local model using training data, can broadcast an indication via the blockchain network 200, which is received at least by the master node 10g. Subsequently, participant node 10f can communicate its shared parameters 15f via the blockchain network 200, which is received by the master node 10g. As a general description, a master node 10g may obtain shared training parameters from each of the participant nodes 10a-10f in the blockchain network 200, which is referred to herein as “parameter sharing.”

During the abovementioned iteration, node 10e can be in the process of restarting itself, after a fault condition. In the example of a connectivity outage (as shown in FIG. 1), the node 10e may not be capable of communicating via the blockchain network 200. In some cases, the node 10e may have been previously completely down. For example, the node 10e may have crashed, causing it to lose all of the dynamic content that has been communicated to the blockchain 200. Continuing with this example, a complete restart of node 10e may be required in this scenario before the node 10e can begin the synchronization portion of the process. In other cases, the node 10e may be recovering from a network partition, as opposed to a failure. A network partition can be generally characterized as a node being partially down. As an example, when the node 10e is network partitioned, it is properly functioning, but cannot communicate to peer nodes in a manner that allows its participation in the collaborative ML process. In these instances, a complete restart of the 10e may not be necessary. The node 10e can begin synchronizing after network connectivity is reestablished. In some embodiments, the node 10e is configured to automatically perform any necessary functions needed to recover from the outages described above, such as an automatic restart. Once the node 10e has recovered from the outage, the blockchain layer of the node 10e can initiate the synchronization protocol as an aspect of its self-healing. As an initial step of synchronization, the self-healing node 10e can obtain blocks from the distributed ledger 42. This allows the self-healing node 10e to retrieve any blocks that may have been missed, or lost, during the outage.

The node 10e can update a local copy of the distributed ledger, thereby obtaining a global ML state and a local ML state. The distributed ledger 42 can maintain a current (e.g., based on the most recent iteration) global ML state based on the collaborative learning from the nodes of the system, and a current local ML state that is respective to the individual learning that is performed locally each of the nodes. Regarding the node 10e, its local ML state maintained by the distributed ledger 42 should include data from the most recent iteration in which the node 10e was a participant. Accordingly, the local ML state reflects the state of the node 10e that was synchronized by the blockchain prior to the fault. Restated, all of the other participant nodes 10a-10d, and 10f are aware that the node 10e is at the state indicated by its local ML state in the distributed ledger 42. Any other local ML state for node 10e, which is inconsistent with the local ML state maintained by the distributed ledger 42, may be a result of corrupt or outdated data. Thus, the synchronization effectively overrides this data with the local ML state obtained from the distributed ledger, in order to ensure that the state has been verified and is consistent throughout the blockchain.

Furthermore, FIG. 2A illustrates that node 10e can generate a blockchain transaction 19 indicating that it is “out-of-sync.” By transmitting this “O-O-S” blockchain transaction 19, the node 10e signals to the network 200 that although it may be recovered from the fault condition, it has yet to complete the synchronization protocol for self-healing, and its potentially out-of-synch with the blockchain network 200. An out-of-sync node can have machine learning data, including a local model, that has not been updated by the most recent iteration of learning. As alluded to above, the fault tolerance techniques can prevent the out-of-sync node 10e from injecting corrupt or stale data into the decentralized model building process by waiting until after the synchronization protocol to allow the node to contribute to ML. In particular, node 10e writing the O-O-S blockchain transaction 19 to the distributed ledger 42 signals to the other participant nodes 10a-10d, and 10f and the master node 10g that it is not ready to share its learning (e.g., local training parameters) with the system. Accordingly, node 10e is still being gradually reintroduced into the system and is not included in the present iteration of model building.

As seen in FIG. 2A, prior to the master node 109 being aware that node 10g is out-of-sync via the O-O-S blockchain transaction 19, the master node 10g may still consider node 10e as being an active part of the population. That is, node 10e may be communicatively connected to the blockchain network 100, for instance being able to provide a heartbeat signal to the master node 10g. The master node 10g, as a result, may consider the node 10e as present in the blockchain network 200, otherwise referred to as the “present” participant node population for purposes of discussion. The master node 10g may include node 10e in the “present” participant node population without yet being aware that node 10e is not ready to properly contribute its local data for parameter sharing (e.g., being synchronized with the blockchain network 200) during the current iteration. In this scenario, the master node 10g can perform an initial comparison of a number of participant nodes that it can communicate with via the blockchain network 200, or the number nodes in the “present” participant node population, to the quorum population threshold. FIG. 2A shows the example where the master node 10g determines that the “present” participant node population (illustrated in FIG. 2A by the dashed-lined box) includes participant nodes 10a-10d, 10f, and node 10e, which is out-of-sync. Furthermore, in the illustrated example, the master node 10g may determine that the “present” node population size is greater than the quorum population threshold, as result of the comparison. Thus, the master node 10g can continue with the current iteration of model building, for now.

Referring now to FIG. 2B, the second phase of the communication is shown. The second phase can generally be described as communication within the blockchain network 200 after the node 10e has been excluded from, at least an iteration, of the model building process. In some embodiments, the master node 10g queries the distributed ledger 42 to determine whether any of the nodes 10a-10e have indicated themselves as “out-of-sync” prior to merging any shared parameters. Accordingly, master node 10g can determine which of the participant nodes 10a-10f are “in-sync” with the blockchain network 200 and ready to actively share their respective training parameters. Further, the master node 10g can apply this state awareness to determine an updated population of participant nodes. This updated population of participant nodes in FIG. 2B is based solely on nodes that are currently synchronized and ready to act as participant nodes (as opposed to the population of present nodes shown in FIG. 2A).

Master node 10g may obtain the O-O-S blockchain transaction 19 from the distributed ledger 42. By receiving the O-O-S blockchain transaction 19, the master node 10g becomes aware that node 10e, although communicating, is not synchronized with the rest of the blockchain network 200 and thus is not ready to act as a participant. Therefore, the master node 10g can exclude node 10e from the population of “ready” participant nodes. As seen in FIG. 2B, nodes 10a-10d, and 10f are included in the ready participant node population (illustrated in FIG. 2B by the dashed-lined box), as determined by the master node 10g. For example, the master node 10g may have received indications broadcasted by nodes 10a-10d, and 10f signaling that the nodes are ready to share their shared training parameters. However, in being aware that node 10e is out-of-sync, the master node 10g can adjust the population to reflect that node 10e cannot currently participate in model building. Also, in some cases, the exclusion of node 10e includes master node 10g not using and/or receiving any shared parameters from node 10e (e.g., based on its local model), in order to prevent the node 10e from potentially injecting corrupt or stale data (due to being out-of-synch) into the decentralized model building process.

Master node 10g can then, using the updated population of FIG. 2B, perform another comparison of the population size to the quorum population threshold. In the illustrated example of FIG. 2B, master node 10g may determine that the “ready” participant node population, which excludes node 10e, is now less than the quorum population threshold. In this case, the loss of node 10e has impacted the system to the point where not enough participant nodes are in the population as contributors to the ML collaboration. As a result, master node 10g, governed by rules of fault tolerance, does not continue the iteration of model building. For instance, node 10g can cause a pausing of the iteration, which includes not merging any shared parameters that may have been received from the participant nodes 10a-10d, and 10f. According to embodiments, the master node 10g can ensure that the model is not degraded in the event that a fault has affected the ML process at a population-level. In some aspects of fault tolerance, the master node 10g waits for a specified amount of time, such as a clock cycle (or an epoch), allowing some time for the system to recover to have a “ready” participant population size that is greater than the quorum population threshold before it can continue with the iteration of model building.

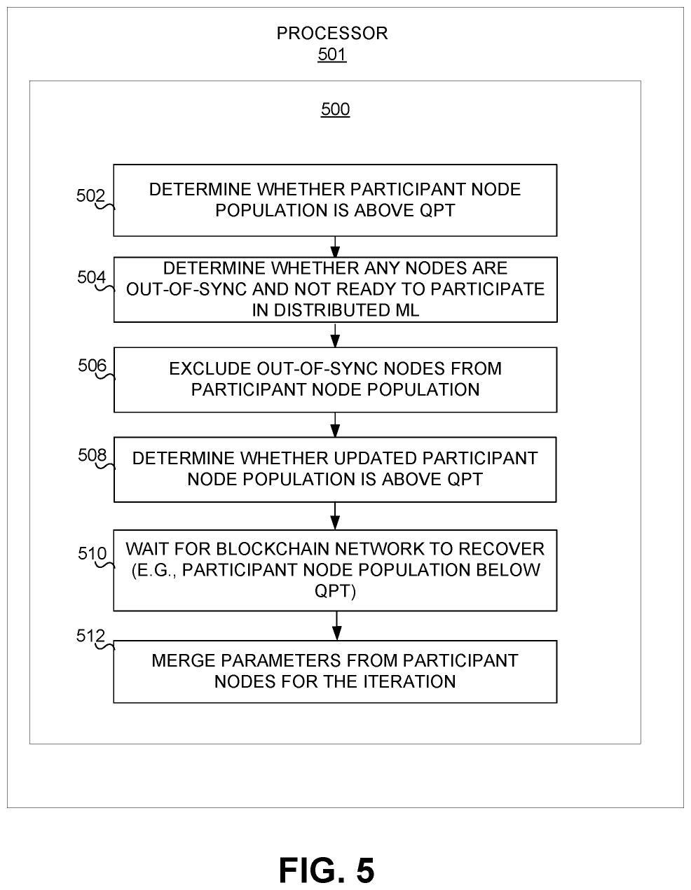

In some embodiments, recovering the population includes node 10e recovering and indicating a successful completion of synchronization with the blockchain network 200. After the node 10e is synchronized, the node 10e can mark itself an being “in-sync” in the distributed ledger 42. Node 10e, according self-healing techniques, can generate a blockchain transaction indicating that it is in-synch (not shown). By transmitting an “I-S” blockchain transaction, the node 10e signals to the network 200 that it has corrected for any potential impacts of the fault and can be reintroduced into the model building process. An “I-S” blockchain transaction can indicate to the master node 10g that node 10e is now ready to share its learning as a participant node during successive iterations of model building and can be included in the “ready” participant node population in FIG. 2B. In an embodiment, receiving the indication from node 10e that is now synchronized (e.g., “I-S” blockchain transaction) with the blockchain network 200, can cause the master node 10g to update the population to again include node 10e. Then, master node 10g can perform another comparison of the most current population size to the quorum population threshold. In other embodiments, the master node 10g checks again after the specified wait time has expired, in order to determine whether any additional nodes might be included in the “ready” node population in a manner that recovers the population size and resumes model building. Details regarding the fault tolerance techniques that can be implemented by the aspects of the embodiments are discussed in reference to FIG. 5. It should be appreciated that fault tolerance techniques enables the system to handle the dynamic nature of node availability in a distributed (or peer-to-peer) environment. Even in the presence of faults, where multiple nodes may be unavailable for a period of time, the embodiments enable a tolerance at the population-level such that data and the overall learning ability of the ML system are not degraded.

Also, in some cases, the master node 10g indicating that it has completed the merge during an iteration of model building, also releases its status as master node for the iteration. In the next iteration a new master node will likely, though not necessarily, be selected. Training may iterate until the training parameters converge. Training iterations may be restarted once the training parameters no longer converge, thereby continuously improving the model as needed through the blockchain network.

Furthermore, dynamic scaling does not cause degradation of model accuracy. By using a distributed ledger 42 to coordinate activity and smart contracts to enforce synchronization by not permitting stale or otherwise uninitialized nodes from participating in an iteration, the stale gradients problem can be avoided. Use of the decentralized ledger and smart contracts (shown in FIG. 1) may also make the system fault-tolerant. Node restarts and other downtimes can be handled seamlessly without loss of model accuracy by dynamically scaling participant nodes and synchronizing learned parameters. Moreover, building applications that implement the ML models for experimentation can be simplified because a decentralized application can be agnostic to the network topology and role of a node in the system.

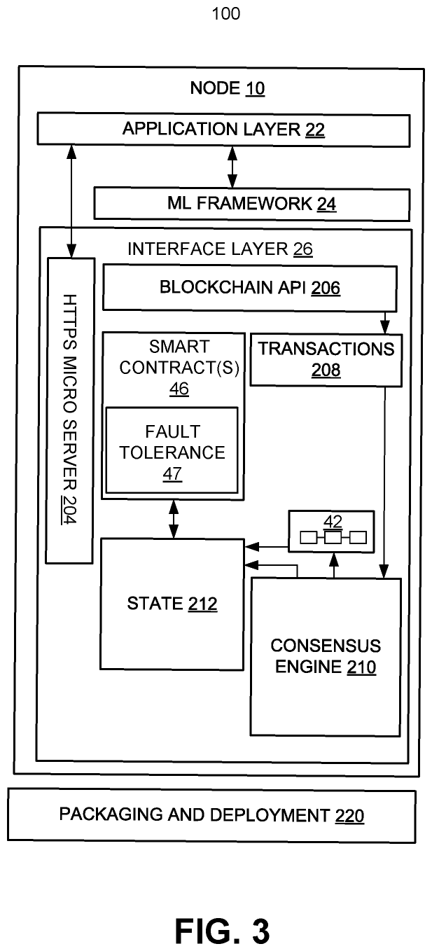

Referring now to FIG. 3, a schematic diagram of a node 10 that is configured for participating in an iteration of machine learning using blockchain is illustrated. FIG. 3 shows an example configuration of the node 10 which includes a fault tolerance module 47 for implementing the fault tolerance aspects disclosed herein. In the illustrated example, the fault tolerance module 47 can be a modular portion of the rules realized by smart contracts 46. As described above, smart contracts 46 may include rules that configure the node 10 to behave in certain ways in relation to decentralized machine learning. In particular, rules encoded by the fault tolerance model 47 can program node 10 to enforce participant population minimums and perform recovery actions in a manner that prevents faults from degrading the decentralized model building process, as previously described. For example, the smart contacts 46 can cause node 10 to use the application layer 22 and the distributed ledger 42 to coordinate parallel model building during an iteration with other participant nodes. Furthermore, the fault tolerance module 47 can use the distributed ledger 42 to drive various population determining aspects of the fault tolerance techniques. The application layer 22 may include a blockchain agent that initiates model training. Even further, the smart contracts 46 can configure the node 10 to communicate the shared parameters (as opposed to raw data).

The interface layer 26 may include a messaging interface used for the node 10 to communicate via a network with other participant nodes. As an example, the interface layer 26 provides the interface that allows node 10 to communicate its shared parameters (shown in FIG. 2B) to the other participating nodes during ML. The messaging interface may be configured as a Secure Hypertext Transmission Protocol (“HTTPS”) microserver 204. Other types of messaging interfaces may be used as well. The interface layer 26 may use a blockchain API 206 to make API calls for blockchain functions based on a blockchain specification. Examples of blockchain functions include, but are not limited to, reading and writing blockchain transactions 208 and reading and writing blockchain blocks to the distributed ledger 42. One example of a blockchain specification is the Ethereum specification. Other blockchain specifications may be used as well. According to some embodiments, after a fault, the self-healing module 47 waits for the blockchain API 206 to be fully operational prior to initiating the self-healing techniques described herein. Thus, the self-healing module 47 safeguards against attempting to perform self-healing functions that that are dependent on the blockchain, such as auto-synchronization.

Consensus engine 210 may include functions that facilitate the writing of data to the distributed ledger 42. For example, in some instances when node 10 operates as a master node (e.g., one of the participant nodes 10), the node 10 may use the consensus engine 210 to decide when to merge the shared parameters from the respective nodes, write an indication that its state 212 has changed as a result of merging shared parameters to the distributed ledger 42, and/or to perform other actions. In some instances, as a participant node (whether a master node or not), node 10 may use the consensus engine 210 to perform consensus decisioning such as whether to enroll a node to participate in an iteration of machine learning. In this way, a consensus regarding certain decisions can be reached after data is written to distributed ledger 42.

In some implementations, packaging and deployment 220 may package and deploy a model 44 as a containerized object. For example, and without limitation, packaging and deployment 220 may use the Docker platform to generate Docker files that include the model 44. Other containerization platforms may be used as well. In this manner various applications at node 10 may access and use the model 44 in a platform-independent manner. As such, the models may not only be built based on collective parameters from nodes in a blockchain network, but also be packaged and deployed in diverse environments.

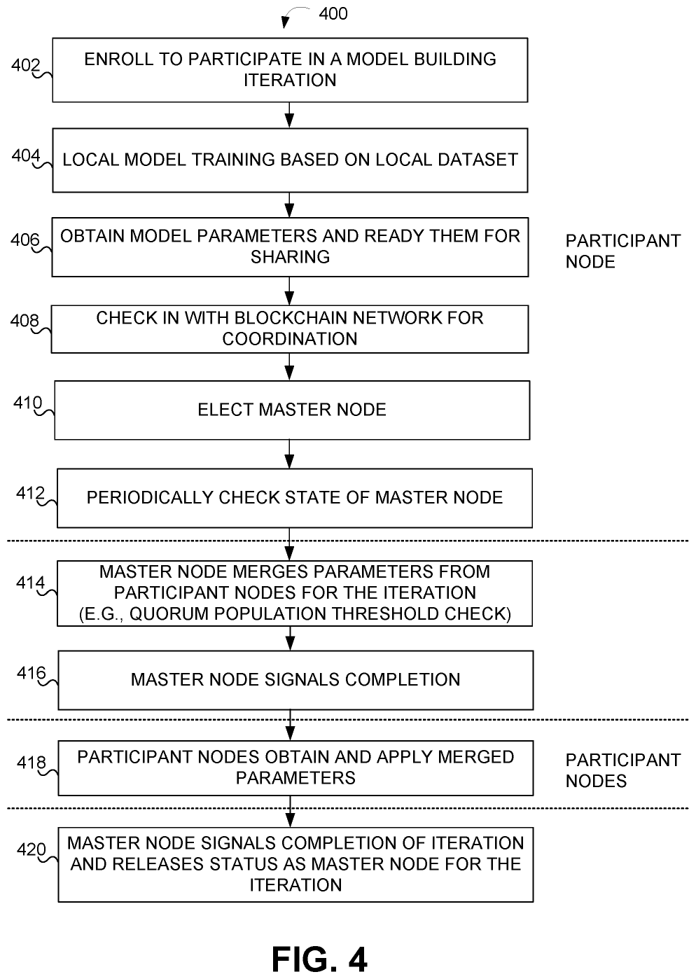

Further details of an iteration of model-building are now described with reference to FIG. 4, which illustrates an example of a process 400 of an iteration of model building using blockchain according to one embodiment of the systems and methods described herein. As illustrated in FIG. 4, operations 402-412 and 418 are applicable to participant nodes, whereas operations 414, 416, and 420 are applicable to master node.

In an operation 402, each participant node may enroll to participate in an iteration of model building. In an implementation, the smart contracts (shown in FIG. 3) may encode rules for enrolling a node for participation in an iteration of model building. The rules may specify required credentials, valid state information, and/or other enrollment prerequisites. The required credentials may impose permissions on which nodes are allowed to participate in an iteration of model building. In these examples, the blockchain network may be configured as a private blockchain where only authorized nodes are permitted to participate in an iteration.

The authorization information and expected credentials may be encoded within the smart contracts or other stored information available to nodes on the blockchain network. The valid state information may prohibit nodes exhibiting certain restricted semantic states from participating in an iteration. The restricted semantic states may include, for example, having uninitialized parameter values, being a new node requesting enrollment in an iteration after the iteration has started (with other participant nodes in the blockchain network), a stale node or restarting node, and/or other states that would taint or otherwise disrupt an iteration of model building. Stale or restarting nodes may be placed on hold for an iteration so that they can synchronize their local parameters to the latest values, such as after the iteration has completed.

Once a participant node has been enrolled, the blockchain network may record an identity of the participant node so that an identification of all participant nodes for an iteration is known. Such recordation may be made via an entry in the distributed ledger. The identity of the participant nodes may be used by the consensus engine (shown in FIG. 3) when making strategic decisions.

The foregoing enrollment features may make model building activity fault tolerant because the topology of the model building network (i.e., the blockchain network) is decided at the iteration level. This permits deployment in real world environments like autonomous vehicles where the shape and size of the network can vary dynamically.

In an operation 404, each of the participant nodes may execute local model training on its local training dataset. For example, the application layer (shown in FIG. 3) may interface with the machine learning framework (shown in FIG. 3) to locally train a model on its local training dataset. In some cases, operation 404 can involve a biased data environment as a result of privacy restrictions. Accordingly, during operation 404, the full data set used for locally training a model at a node may include some private data, thus causing the full data set to be not be accessible at other participant nodes without compromising its privacy. Model building process 400 employs parameter sharing techniques which enable privacy of data to be preserved during the collaborative model-building process 400. Additionally, parameter sharing allows a node's local model to be updated using the learning performed by other participant nodes in the blockchain network. Thus, the parameter sharing techniques can be advantageous in fault scenarios, where a node may be down and unable to participate in a few iterations of model building. For example, in the realm of self-healing, a node that is recovering from a fault may use shared training parameters from its peers (or merged training parameters from the master node) to update its local model, as opposed to applying its local data that may be potentially stale. As discussed in greater detail in reference to FIG. 5, parameter sharing can be employed as a corrective action used to re-synchronize a self-healing node with the blockchain network.

In an operation 406, each of the participant nodes may generate local parameters based on the local training and may keep them ready for sharing with the blockchain network to implement parameter sharing. For example, after the local training cycle is complete, the local parameters may be serialized into compact packages that can be shared with rest of the blockchain network, in a manner similar to the shared parameters illustrated in FIG. 2A. Such sharing may be facilitated through making the shared parameters available for download and/or actively uploading them through peer-to-peer or other data transmission protocols. In some embodiments, the smart contracts may encode rules for a node to communicate, or otherwise share, its shared parameters.

In an operation 408, each participant node may check in with the blockchain network for co-ordination. For instance, each participant node may signal the other participant nodes in the blockchain network that it is ready for sharing its shared parameters. In particular, each participant node may write a blockchain transaction using, for example, the blockchain API (shown in FIG. 3) and broadcast the blockchain transaction via the messaging interface and the blockchain API. Such blockchain transactions may indicate the participant node's state (e.g., that it is ready to share its local parameters), a mechanism for obtaining the shared parameters, a location at which to obtain the shared parameters, and/or other information that conveys the readiness of a node for sharing or identification of how to obtain the shared parameters from other participant nodes. The transactions may be queued in a transaction queue or pool from which transactions are selected. These transactions may be timestamped and selected from, in some examples, in a first-in-first-out (“FIFO”) manner.

In an operation 410, participant nodes may collectively elect a master node for the iteration. For example, the smart contracts may encode rules for electing the master node. Such rules may dictate how a participant node should vote on electing a master node (for implementations in which nodes vote to elect a master node). These rules may specify that a certain number and/or percentage of participant nodes should be ready to share its shared parameters before a master node should be elected, thereby initiating the sharing phase of the iteration. It should be noted, however, that election of a master node may occur before participant nodes 10 are ready to share their shared parameters. For example, a first node to enroll in an iteration may be selected as the master node. As such, election (or selection) of a master node per se may not trigger transition to the sharing phase. Rather, the rules of smart contracts may specify when the sharing phase, referred to as phase 1 in reference to FIG. 2A, should be initiated, thereby ensuring this transition occurs in a deterministic manner.

The master node may be elected in various ways other than or in addition to the first node to enroll. For example, a particular node may be predefined as being a master node. When an iteration is initiated, the particular node may become the master node. In some of these instances, one or more backup nodes may be predefined to serve as a master node in case the particular node is unavailable for a given iteration. In other examples, a node may declare that it should not be the master node. This may be advantageous in heterogeneous computational environments in which nodes have different computational capabilities. One example is in a drone network in which a drone may declare it should be not the master node and a command center may be declared as the master node. In yet other examples, a voting mechanism may be used to elect the master node. Such voting may be governed by rules encoded in a smart contract. This may be advantageous in homogeneous computational environments in which nodes have similar computational capabilities such as in a network of autonomous vehicles. Other ways to elect a master node may be used according to particular needs and based on the disclosure herein.

In an operation 412, participant nodes that are not a master node may periodically check the state of the master node to monitor whether the master node has completed generation of the merged parameters based on the shared parameters that have been locally generated by the participant nodes. For example, each participant node may inspect its local copy of the distributed ledger, within which the master node will record its state for the iteration on one or more blocks.

In an operation 414, the master node may enter a sharing phase in which some or all participant nodes are ready to share their shared parameters. For instance, the master node may obtain shared parameters from participant nodes whose state indicated that they are ready for sharing. Using the blockchain API, the master node may identify transactions that both: (1) indicate that a participant node is ready to share its shared parameters and (2) are not signaled in the distributed ledger. In some instances, transactions in the transaction queue have not yet been written to the distributed ledger. Once written to the ledger, the master node (through the blockchain API) may remove the transaction from or otherwise mark the transaction as confirmed in the transaction queue. The master node may identify corresponding participant nodes that submitted them and obtain the shared parameters (the location of which may be encoded in the transaction). The master node may combine the shared parameters from the participant nodes to generate merged parameters for the iteration based on the combined shared parameters. It should be noted that the master node may have itself generated local parameters from its local training dataset, in which case it may combine its local parameters with the obtained shared parameters as well. Consequently, the master node can combine all of the individual learning from each of the participant nodes across the blockchain network during the distributed process. For example, operation 414 can be described as compiling the learned patterns from training local model at each of the participant node using by merging the shared parameters. As alluded to above, at operation 414, the master node can use shared parameters from training the models, rather than the raw data used to build the models to aggregate the distributed learning. In an implementation, the master node may write the transactions as a block on the distributed ledger, for example using blockchain API. Additionally, operation 414 may involve the master node performing a check in accordance with the fault tolerance techniques disclosed herein, prior to merging parameters from the participant nodes. For instance, the master node can check whether the population of participant nodes is greater than the quorum population threshold, thereby determining that the at least the minimum number of participant nodes have shared their respective learning. The process particularly related to the fault tolerance aspects of decentralized model building is discussed in greater detail in reference to FIG. 5. Accordingly, the iteration of model building can continue, and the master node merges the shared parameters at operation 414.

In an operation 416, the master node may signal completion of the combination. For instance, the master node may transmit a blockchain transaction indicating its state (that it combined the local parameters into the final parameters). The blockchain transaction may also indicate where and/or how to obtain the merged parameters for the iteration. In some instances, the blockchain transaction may be written to the distributed ledger.

In an operation 418, each participant node may obtain and apply the merged parameters on their local models. For example, a participant node may inspect its local copy of the distributed ledger to determine that the state of the master node indicates that the merged parameters are available. The participant node may then obtain the merged parameters. It should be appreciated that the participant nodes are capable of obtaining, and subsequently applying, the combined learning associated with the merged parameters (resulting from local models) such that it precludes the need to transmit and/or receive full training datasets (corresponding to each of the local model). Furthermore, any private data that is local to a participant node and may be part of its full training dataset can remain protected.

In an operation 420, the master node may signal completion of an iteration and may relinquish control as master node for the iteration. Such indication may be encoded in the distributed ledger for other participant nodes to detect and transition into the next state (which may be either applying the model to its particular implementation and/or readying for another iteration.

By recording states on the distributed ledger and related functions, the blockchain network may effectively manage node restarts and dynamic scaling as the number of participant nodes available for participation constantly changes, such as when nodes go on-and-offline, whether because they are turned on/turned off, become connected/disconnected from a network connection, and/or other reasons that node availability can change.

FIG. 5 illustrates an example of a process 500 at a node, which performs fault tolerance during decentralized model building. In some cases, the process 500 may occur during an iteration of model building, as previously described in reference to FIG. 4. Process 500 is illustrated as a series of executable operations performed by processor 501, which can be the processor of a node (shown in FIG. 1) acting as a master node. The node may also have the capability to detect that a participant node in the blockchain network has undergone an intermittent fault, such as a connectivity outage. According to some embodiments, detection of a fault by the master node triggers the fault tolerance process 500. As alluded to above, a participant node experiencing a fault can perform self-healing to reintegrate itself back into the decentralized model building process. In response, the master node may perform the fault tolerance process 500 to ensure that the intermittent loss of the participant node, both during its connectivity unavailability and self-healing, does not impact the precision of model building. Processor 501 executes the operations of process 500, thereby implementing the disclosed fault tolerance techniques. The process 500 can be executed automatically by a node, after it has detected fault condition, as previously described. However, in some embodiments, the master node may perform aspects of the fault tolerance techniques at each iteration of model building. For example, referring back to the parameter sharing process of FIG. 4, the master node may, at least perform the participant node population checking portion of process 500 before merging the shared parameters at every iteration.

In an operation 502, the node can determine whether a number of participant nodes within the participant node population is above the quorum population threshold. As previously discussed, the master node may have initiated the parameter sharing process, where it is prepared to merge shared parameters from the participant nodes on the blockchain network. In some embodiments, operation 502 can include the master node receiving a presence indication, such as a heartbeat signal or a blockchain transaction, from each of the participant nodes that are communicatively connected to the blockchain network. For example, a node that is currently experiencing a connectivity outage may not be connected to the blockchain network in a manner that allows the master node to receive an indication of its presence. As such, a node that is disconnected, or otherwise unavailable via the blockchain network, may not be considered as part of the participant node population in operation 502. Furthermore, in referring back to the example in FIG. 2B, the master node may include a node that is available on the blockchain network, but still out-of-sync with the blockchain network, as part of the “present” participant node population. Thus, operation 502 can be generally considered an initial comparison of the participant node population against the quorum population threshold. Each node that has “checked-in” to the blockchain network, by indicating its presence to the master node, may be counted as part of the population for the comparison at operation 502. In some cases, the quorum population threshold is a minimum number of participant nodes that must be ready to share its shared training parameters in order for the master node to write indications to a distributed ledger that it is performing an iteration of the shared parameters process (e.g., receiving and/or merging shared parameters).

In some instances, operation 502 can further include determining a subset of the “present” participant node population. That is, there may be a subset only including the nodes that have all of their exposed service ports be reachable. For purposes of discussion, this subset of nodes can be referred to as the “accessible” participant node population. Accordingly, operation 502 may use the number of nodes within the determined “accessible” participant node population to compare against the quorum population threshold. The “accessible” participant node population may be used in addition to, or in lieu of, the abovementioned “present” participant node population. In cases where it is determined, based on the results of the comparison at operation 502, that the participant node population meets or exceeds the quorum population threshold, the process 500 may proceed to operation 504. Alternatively, in cases where operation 502 determines that the participant node population is less than the quorum population threshold, then the master node may decide to stop (e.g., temporarily) the current iteration of model building. In some embodiments, the master node stopping the model building process after the comparison at operation 502 may cause the process 500 to proceed to operation 510. According to this embodiment, the master node waits for the population to recover (e.g., performing one of more recovery actions) at operation 510, under the assumption that model building will resume. In an alternate embodiment, the master node may completely stop the model building process after the comparison at operation 502 determines that the population size is less than the threshold, as it may be indicative of larger scale issues (e.g., catastrophic connectivity issues or problems at the blockchain layer).

Next, at operation 504, the master node may determine whether any of the participant nodes are currently “out-of-sync.” As previously described, a node that may be self-healing after experiencing a fault can be out-f-sync, in the early stages of being reintroduced into the blockchain network. In accordance with self-healing techniques, the node may communicate an “out-of-sync” blockchain transaction to the distributed ledger (shown in FIG. 2A). Thus, operation 504 may involve the master node obtaining the “out-of-sync” blockchain transaction, serving as an indication that the node may not have a model that is synchronized with the most recent iteration of ML. Thus, in response to determining that there is at least one out-of-sync node, based on the “out-of-sync” blockchain transaction, at operation 504 the process may continue to operation 506.

At operation 506, the master node can exclude any nodes that are determined to be “out-of-sync” with the blockchain network. As alluded to above, an out-of-sync node is typically not ready for parameter sharing. Thus, operation 506 can involve the master node excluding out-of-sync nodes from participating in the iteration of training the ML model. The exclusion by the master node, can cause the out-of-sync node to effectively “wait” (e.g., for a complete iteration or epoch), and prevents any training parameters at the out-of-sync node from being applied to the model building for an iteration, for example. Additionally, in accordance with the disclosed fault tolerance techniques, the master node similarly excludes the node from the participant node population at operation 506. For example, operation 506 may involve the master node updating the “present” participant node population related to previous operation 502, by removing any found out-of-sync nodes that are not ready to act as participants in model building. As a result, operation 506 can be described as determining the “ready” participant node population, as shown in FIG. 2B. The “ready” participant node population can be restricted to only include the participant nodes that can properly contribute their learning during the current iteration of model building (e.g., synchronized). In instances where no nodes are found to be out-of-sync at operation 506, it can signify that the current participant node population size is sufficient for safely continuing with the iteration of model building, and the process 500 can continue to operation 512. For example, synchronization will not impact the population size if none of the participant nodes are out-of-sync, and the population has already been checked against the quorum population threshold at previous operation 502.

Alternatively, if the participant node population has been updated due to excluding one or more out-of-sync nodes at 506, the process 500 goes to operation 508.

Next, at operation 508, the master node can compare a number of nodes in the abovementioned “ready” participant node population to the quorum population threshold. The quorum population threshold for the comparison in operation 508 may be the same as the threshold applied in operation 502. In some embodiments, the comparison of operation 502 and 508 can use a respective threshold value that may be different, as to reflect different minimum requirements. As an example, a quorum population threshold that is applied to the “present” participant node population at operation 502 may be higher, as compared to a lower value for the threshold that may be used for the “ready” participant node population (accounting for the assumption that some present nodes may be out-of-sync). If the check at operation 508 determines that the “ready” participant node population is above (meets or exceeds) the quorum population threshold, then the minimum number of participant nodes are ready for parameter sharing and the process 500 can go to operation 512.

In contrast, if the check at operation 508 determines that the “ready” participant node population is less than the quorum population threshold, then the master node “waits” at operation 510. According to the embodiments, the master node may not receive and/or merge any shared parameters from the participant nodes in the blockchain network during operation 510, which effectively pauses model building. Waiting in operation 510 may be for a specified time, such as a full iteration (e.g., epoch) or based on detecting a particular event that may be indicative of recovery, such a obtaining a blockchain transaction that indicates re-synchronization of a node.

As previously described, an aspect of fault tolerance can involve recovery of the population such that the number of participant nodes is above the quorum population threshold. For instance, recovery may involve a self-healing node performing one or more corrective actions. A self-healing node can be aware that its current ML state is stale, or out-of-date, with respect to the most recent iteration of model building performed by another participant node on the blockchain network. As a result, the self-healing node can automatically perform corrective actions to recover its local ML state to the point of the global ML state. In this embodiment, during the waiting at operation 510, a node may execute multiple corrective actions, such as gradient sharing, parameter sharing, and the like. It should be understood that any method, process, or algorithm that allows the local ML state to be recovered using the state of peer nodes in the blockchain network to achieve consistency with the global ML state can be used for re-synchronizing a node during operation 510. In the case of gradient sharing, the self-healing node can acquire the latest ML checkpoint from at least one healthy peer and apply it to update is local model. Parameter sharing can also be performed to recover out-of-sync nodes, for example, in the manner described above in reference to FIG. 4.

In an embodiment, after the wait time has expired (or the event signifying recovery of one or more nodes detected) at operation 510, the number of participant nodes in the population can be reevaluated. As previously described, a master node can update the “ready” participant node population to include any newly re-synchronized nodes. Subsequently, the population is again compared against the quorum population threshold at operation 510 to determine whether the population size has recovered to the required minimum number of participants. If the participant node population has fully recovered, the iteration of model building can resume, and the process 500 proceeds to operation 512. If the participant node has not fully recovered, for example only a single self-healing node has been reintroduced into the ML process while a substantial number of other nodes remain out-of-sync, the process 500 may continue to wait. Operation 510 may be executed iteratively, continuing to wait until the participant node population has reach a point of full recovery and is above the threshold.

Subsequently, at operation 512, the iteration of model building is allowed to continue, after it has been determined that the system has a desirable number of participant nodes to maintain precision of the ML model. In some embodiments, the iteration resumes with the master node merging shared parameters from each of the participant nodes. Merging of shared parameters at operation 512 is performed in a manner similar to that described above in reference to FIG. 4 and is not discussed in detail again for purposes of brevity.

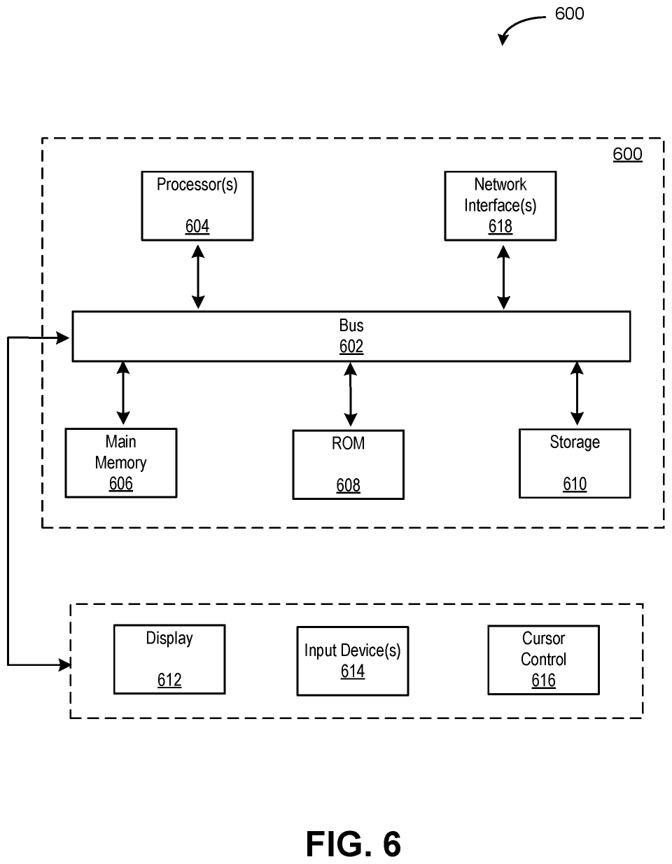

FIG. 6 depicts a block diagram of an example computer system 600 in which fault tolerance embodiments described herein may be implemented. Furthermore, it should be appreciated that although the various instructions are illustrated as being co-located within a single processing unit, such as the node (shown in FIG. 1), in implementations in which processor(s) includes multiple processing units, one or more instructions may be executed remotely from the other instructions.

The computer system 600 includes a bus 602 or other communication mechanism for communicating information, one or more hardware processors 604 coupled with bus 602 for processing information. Hardware processor(s) 604 may be, for example, one or more general purpose microprocessors.

The computer system 600 also includes a main memory 606, such as a random access memory (RAM), cache and/or other dynamic storage devices, coupled to bus 602 for storing information and instructions to be executed by processor 604. Main memory 606 also may be used for storing temporary variables or other intermediate information during execution of instructions to be executed by processor 604. Such instructions, when stored in storage media accessible to processor 604, render computer system 600 into a special-purpose machine that is customized to perform the operations specified in the instructions.

The computer system 600 further includes a read only memory (ROM) 608 or other static storage device coupled to bus 602 for storing static information and instructions for processor 604. A storage device 610, such as a magnetic disk, optical disk, or USB thumb drive (Flash drive), etc., is provided and coupled to bus 602 for storing information and instructions.

The computer system 600 may be coupled via bus 602 to a display 612, such as a liquid crystal display (LCD) (or touch screen), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. In some embodiments, the same direction information and command selections as cursor control may be implemented via receiving touches on a touch screen without a cursor.

The computing system 600 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor(s) 604 executing one or more sequences of one or more instructions contained in main memory 606. Such instructions may be read into main memory 606 from another storage medium, such as storage device 610. Execution of the sequences of instructions contained in main memory 606 causes processor(s) 604 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 610. Volatile media includes dynamic memory, such as main memory 606. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 602. Transmission media can also take the form of acoustic or light waves, such as those generated during radio-wave and infra-red data communications.

The computer system 600 also includes a communication interface 618 coupled to bus 602. Network interface 618 provides a two-way data communication coupling to one or more network links that are connected to one or more local networks. For example, communication interface 618 may be an integrated services digital network (ISDN) card, cable modem, satellite modem, or a modem to provide a data communication connection to a corresponding type of telephone line. As another example, network interface 618 may be a local area network (LAN) card to provide a data communication connection to a compatible LAN (or WAN component to communicated with a WAN). Wireless links may also be implemented. In any such implementation, network interface 618 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through communication interface 618, which carry the digital data to and from computer system 600, are example forms of transmission media.

The computer system 600 can send messages and receive data, including program code, through the network(s), network link and communication interface 618. In the Internet example, a server might transmit a requested code for an application program through the Internet, the ISP, the local network and the communication interface 618.

The received code may be executed by processor 604 as it is received, and/or stored in storage device 610, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 600.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A system of decentralized machine learning (ML) comprising:
a plurality of computer nodes on a decentralized network, each of the plurality of computer nodes being programmed to:
train a respective local model based on a respective local training dataset during a current iteration of training a machine learning model;
generate training parameters at a respective computer node based on the respective local model; and
generate a blockchain transaction comprising at least an indication that the respective computer node is present on the decentralized network to share the training parameters for participating in the current iteration of training;
a master node on the decentralized network being programmed to:
receive indications from each of the plurality of computer nodes that are present on the decentralized network for participating in the current iteration of training;
determine a number of computer nodes corresponding to a population of computer nodes that are present on the decentralized network for participating in the current iteration of training based on the received indications;
determine whether the number of computer nodes is above a predefined threshold; and
upon determining that the number of computer nodes is above the predefined threshold, perform operations for the current iteration of training.

2. The system of claim 1, wherein the predefined threshold indicates a minimum number of computer nodes in the population of computer nodes for participating in an iteration of training that is required for completing the iteration.

3. The system of claim 2, wherein the master node is further programmed to:
prior to continuing to perform operations for the current iteration of training, receive out-of-sync indications from each of the plurality of computer nodes on the decentralized network that are out-of-sync with the current iteration of training, wherein blockchain transactions comprise the out-of-sync indications;
determine a number of out-of-sync computer nodes that corresponds to the received out-of-sync indications, wherein the number of out-of-sync computer nodes represents a group of computer nodes that are present on the decentralized network and not ready for participating in the current iteration of training;
exclude the number of out-of-sync computer nodes from the number of computer nodes in the population to further determine an updated number of computer nodes in the population, wherein the updated number of computer nodes represents a population of computer nodes that are present on the decentralized network and ready to share their respective shared training parameters for participating in the current iteration of training;
determine whether the updated number of computer nodes in the population is above the predefined population threshold; and
upon determining that the updated number of computer nodes in the population is above the predefined population threshold, continue to perform operations for the current iteration of training.

4. The system of claim 3, wherein the master node is further programmed to:
exclude the out-of-sync computer nodes from participating in the current iteration of training based on the out-of-sync indications such that their respective shared training parameters are prevented from being applied to the machine-learned model.

5. The system of claim 3, wherein the master node is further programmed to:
upon determining that the number of computer nodes in the population is below the predefined population threshold, wait for the population to recover by pausing from performing operations for the current iteration of training for a specified time period;
after the specified time period, determine whether the population is recovered to include a number of computer nodes that is above the predefined population threshold; and
upon determining that the population is recovered, continue to perform operations for the current iteration of training.

6. The system of claim 5, wherein the population recovers from a fault condition of at least one of the plurality of computer nodes on the decentralized network, the fault condition comprising one of:
network connectivity outage, power outage, or computer node crash.

7. The system of claim 6, wherein each of the plurality of computer nodes are further programmed to:
automatically perform one or more corrective actions to recover from the fault condition.

8. The system of claim 5, wherein waiting for the population to recover enables training of the machine-learned model to tolerate the fault condition.

9. The system of claim 5, wherein the master node is further programmed to:
upon continuing to perform operations for the current iteration of training, obtain shared training parameters from the computer nodes in the population for participating in the current iteration of training;
generate merged training parameters based on the shared training parameters;
generate a transaction that includes an indication that the master node has generated the merged training parameters;
cause the transaction to be written as a block on the distributed ledger; and
make the merged training parameters available to each of the computer nodes in the population for participating in the current iteration of training.

10. The system of claim 9, wherein each of the plurality of computer nodes are further programmed to:
upon the master node continuing to perform operations for the current iteration of training, obtain merged training parameters from the master node; and
apply the merged training parameters to the local model.

11. A method of decentralized machine learning (ML) including fault tolerance, comprising:
training, by each of a plurality of nodes on a decentralized network, a local model based on a local training dataset during a current iteration of training a machine-learned model;
generating, by each of the plurality of nodes, shared training parameters based on the local model; and
generating, by each of the plurality of nodes, a blockchain transaction comprising an indication that the computer node is present on the decentralized network to share the shared training parameters for participating in the current iteration of training;
receiving, by a master node on the decentralized network, indications from each of the plurality of computer nodes that are present on the decentralized network for participating in the current iteration of training, wherein the master node is selected from among the plurality of computer nodes participating in the current iteration of training;
determining, by the master node, a number of computer nodes that corresponds to the received indications, wherein the number of computer nodes represents a population of computer nodes that are present on the decentralized network for participating in the current iteration of training;
determining, by the master node, whether the number of computer nodes in the population is above a predefined population threshold; and
upon determining that the number of computer nodes in the population is above the predefined population threshold, continuing, by the master node, to perform operations for the current iteration of training.

12. The method of claim 11, wherein the predefined population threshold indicates a minimum number of computer nodes in a population for participating in an iteration of training that is required for completing the iteration.

13. The method of claim 12, further comprising:
prior to continuing to perform operations for the current iteration of training, receiving, by the master node, an out-of-sync indications from each of the plurality of computer nodes on the decentralized network that are out-of-sync with the current iteration of training, wherein blockchain transactions comprise the out-of-sync indications;
determining, by the master node, a number of out-of-sync computer nodes that corresponds to the received out-of-sync indications, wherein the number of out-of-sync computer nodes represents a group of computer nodes that are present on the decentralized network and not ready for participating in the current iteration of training;
excluding, by the master node, the number of out-of-sync computer nodes from the number of computer nodes in the population to further determine an updated number of computer nodes in the population, wherein the updated number of computer nodes represents a population of computer nodes that are present on the decentralized network and ready to share their respective shared training parameters for participating in the current iteration of training;
determining, by the master node, whether the updated number of computer nodes in the population is above the predefined population threshold; and
upon determining that the updated number of computer nodes in the population is above the predefined population threshold, continuing, by the master node, to perform operations for the current iteration of training.

14. The method of claim 13, further comprising:
excluding, by the master node, the out-of-sync computer nodes from participating in the current iteration of training based on the out-of-sync indications such that their respective shared training parameters are prevented from being applied to the machine-learned model.

15. The method of claim 13, further comprising:
upon determining that the number of computer nodes in the population is below the predefined population threshold, waiting, by the master node, for the population to recover by pausing from performing operations for the current iteration of training for a specified time period;
after the specified time period, determining, by the master node, whether the population is recovered to include a number of computer nodes that is above the predefined population threshold; and
upon determining that the population is recovered, continuing, by the master node, to perform operations for the current iteration of training.

16. The method of claim 15, wherein the population recovers from a fault condition of at least one of the plurality of computer nodes on the decentralized network, the fault condition comprising one of:
network connectivity outage, power outage, or computer node crash.

17. The method of claim 16, comprising:
automatically performing, by each of the plurality of computer nodes, one or more corrective actions to recover from the fault condition.

18. The method of claim 15, wherein waiting for the population to recover enables training of the machine-learned model to tolerate the fault condition.

19. The method of claim 15, comprising:
upon continuing to perform operations for the current iteration of training, obtaining, by the master node, shared training parameters from the computer nodes in the population for participating in the current iteration of training;
generating, by the master node, merged training parameters based on the shared training parameters;
generating, by the master node, a transaction that includes an indication that the master node has generated the merged training parameters;
causing, by the master node, the transaction to be written as a block on the distributed ledger; and
making, by the master node, the merged training parameters available to each of the computer nodes in the population for participating in the current iteration of training.

20. The method of claim 19, comprising:
upon the master node continuing to perform operations for the current iteration of training, obtaining, by each of the plurality of computer nodes, merged training parameters from the master node; and
applying, by each of the plurality of computer nodes, the merged training parameters to the local model.
